(19) United States
(12) Patent Application Publication
(10) Pub. No.: US 2012/0102425 A1
(43) Pub. Date: Apr. 26, 2012

(54) ELECTRONIC APPARATUS AND PAGE FLIPPING METHOD THEREFOR

(75) Inventor: WEI SONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/077,993

(22) Filed: Apr. 1, 2011

(30) Foreign Application Priority Data
Oct. 22, 2010 (CN) 201010516267.8

(51) Int. Cl. G06F 3/048

(52) U.S. Cl. 715/776

(57) ABSTRACT

An electronic reading apparatus includes a display unit, and a processing unit. The display unit displays visual information to users; and the processing unit displays a page flipping interface on the display unit. The page flipping interface contains a preview area and an input area. The processing unit determines a sliding direction and a sliding distance of a sliding operation on the input area and determines a flipping direction and a number of pages needed to be flipped corresponding to the sliding direction and the sliding distance. In addition, displays information of the page after flipping pages corresponding to the sliding direction and the sliding distance in the preview area and displays the page outside the page flipping interface. A page flipping method is also provided.

### BACKGROUND

1. Technical Field

The present disclosure relates to electronic apparatuses and, particularly, to an electronic reading apparatus and a page flipping method for the electronic reading apparatus.

2. Description of the Related Art

When flipping through a file displayed on an electronic device such as on an electronic reading apparatus, readers can page through a file by repeatedly pressing page buttons on the electronic reading apparatus. However, this repeated process may cause the readers to feel tired and bored.

### BRIEF DESCRIPTION OF THE DRAWINGS

The components of the drawings are not necessarily drawn to scale, the emphasis instead being placed upon clearly illustrating the principles of an electronic reading apparatus and a page flipping method for the electronic reading apparatus. Moreover, in the drawings, like reference numerals designate corresponding parts throughout multiple views.

FIG. 1 is a schematic view of an electronic reading apparatus displaying a page flipping interface in accordance with an exemplary embodiment.

FIG. 2 is a block diagram of the electronic reading apparatus of FIG. 1.

FIG. 3 is a flowchart of a page flipping method applied in the electronic reading apparatus of FIG. 1, in accordance with an exemplary embodiment.

FIG. 4 is a flowchart of displaying the page flipping interface provided by the electronic reading apparatus of FIG. 1.

### DETAILED DESCRIPTION

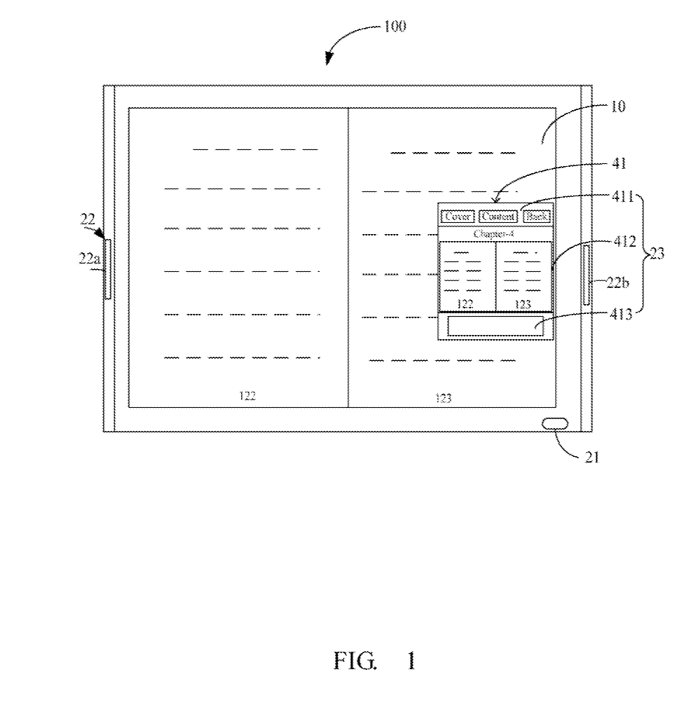

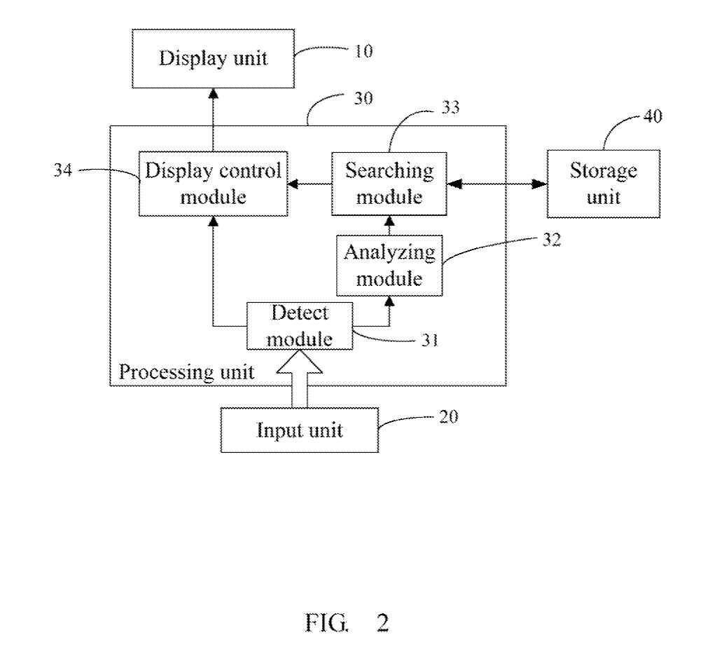

Referring to FIGS. 1 and 2, an electronic reading apparatus 100 includes a display unit 10, an input unit 20, a processing unit 30, and a storage unit 40. The processing unit 30 obtains a page flipping interface 41 from the storage unit 40, displays the page flipping interface 41 on the display unit 10, and searches a desired page via the page flipping interface 41 according to input signals generated by the input unit 20.

The storage unit 40 is configured to store reading files and the page flipping interface 41. The page flipping interface 41 includes a menu area 411, a preview area 412 and an input area 413. In the embodiment, a touch panel 23 overlays the menu area 411 and the input area 413. A sliding bar is displayed in the input area 413 and configured to be dragged by a user to operate the electronic reading apparatus 100. The menu area 411 displays a cover button, a catalog button, and a backward button. When the cover button is clicked, a number of icons of covers of the reading files are displayed on the preview area 412 for providing a selection of a desired reading file for the user. When the desired reading file is selected, a cover or a homepage of the desired reading file is displayed on the preview area 412. Moreover, the user can click the catalog button to display the catalog of the desired reading file on the preview area 412 to search a chapter, section or page number of a desired title also displayed on the preview area 412. The backward button is configured to return to a previously displayed page.

In the embodiment, the input unit 20 includes a read mode button 21, two interface buttons 22. The read mode button 21 generates read mode signals in response to the operation of users to cause the electronic reading apparatus 100 to enter a read mode. The interface buttons 22 includes a left interface button 22a and a right interface button 22b. When the user operates the left interface button 22a, the processing unit 30 displays the page flipping interface 41 on the left side of the display unit 10; when the right interface button 22 is operated, the processing unit 30 displays the page flipping interface 41 on the right side of the display unit 10. The page flipping interface 41 shields portions of the current page on the electronic reading apparatus 100. In the embodiment, the page flipping interface 41 displays information on the current page, including the content and the page number of the current page, and the chapter containing the current page. The users can operate the sliding bar in the input area 413 to change the content on the page flipping interface 41 (described in detail below).

The processing unit 30 also includes a detect module 31 and an analyzing module 32. The detect module 31 is configured to detect sliding signals generated by the input area 413 in response to a sliding operation applied to the sliding bar, and transmit the sliding signals to the analyzing module 32. The analyzing module 32 determines the time of the sliding operation according to the sliding signals. If the time exceeds a preset time T, the analyzing module 32 forwards the sliding signals to the searching module 33. The searching module 33 determines a sliding direction and a sliding distance of the sliding operation according to the sliding signals and determines a flipping direction and a number of pages needed to be flipped. The flipping direction corresponds to the sliding direction and the number of pages to be flipped corresponds to the sliding distance of the sliding operation. In the preferred embodiment, a table stored in the storage unit 40 records a relationship between the sliding distance and the number of pages to be flipped. The relationship may be a direct proportion relation or other suitable relation. The display control module 34 displays information of the page after flipping pages corresponding to the sliding direction and the sliding distance in the preview area 412. If users continuously slide the sliding bar, the information on the preview area 412 is continuously updated, that is, the page and the page number on the preview area is continuously updated. Users can search their desired pages by dragging the sliding bar and reading the content on the page flipping interface 41. If a desired page is found and the user stops dragging the sliding bar for a first preset time period T1, the detect module 31 does not detect any sliding signal in the first preset time period T1, the detect module 31 signals the display control module 34 to display the desired page outside the page flipping interface 41.

In the embodiment, the detect module 31 signals the display control module 34 to stop displaying the page flipping interface 41 if the detect module 31 does not detect any sliding signal within a second preset time period T2.

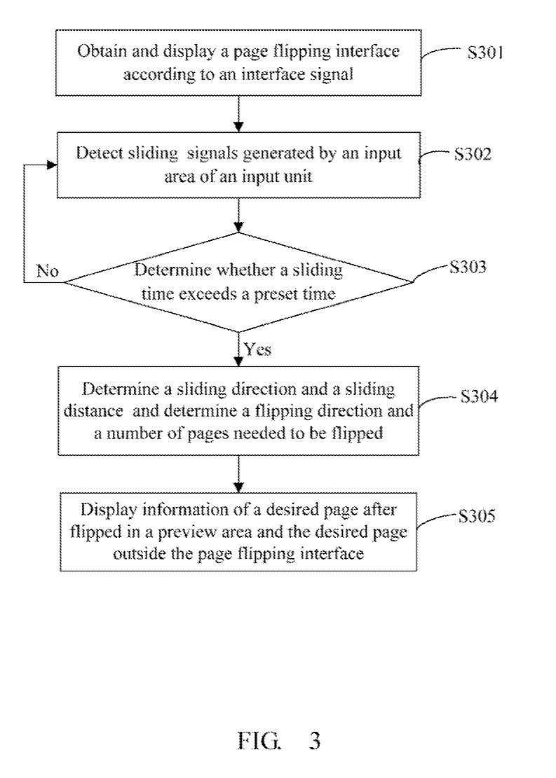

Referring to the FIG. 3, a page flipping method is applied in the electronic reading apparatus 100 in accordance with an exemplary embodiment. The electronic reading apparatus 100 includes a display unit 10, an input unit 20, a processing unit 30, and a storage unit 40. The storage unit 40 is configured to store reading files and page flipping interface 41.

In step S301, a display control module 34 obtains the page flipping interface 41 from the storage unit 40, and displays the page flipping interface 41 on the display unit 10 according to an interface signal generated by the input unit 20 in response to the operations of the users. The page flipping interface 41 includes the menu area 411, the preview area 412 and the input area 413.

In step S302, a detect module 31 detects sliding signals generated by the input area 413 and transmits the sliding signals to an analyzing module 32.

In step S303, The analyzing module 32 determines the time of the sliding operation according to the sliding signals.

If the sliding time exceeds a preset time T, in step S304, the analyzing module 32 forwards the sliding signals to the searching module 33. The searching module 33 determines a sliding direction and a sliding distance of the sliding operation according to the sliding signals and determines a flipping direction and a number of pages that need to be flipped. The flipping direction corresponds to the sliding direction and the number of pages to be flipped corresponds to the sliding distance of the sliding operation. A table is stored in the storage unit 40 and records a relationship between the sliding distance and the number of pages to be flipped. Otherwise, the procedure returns to step S302.

In step S305, The display control module 34 displays information of a desired page after being flipped on the preview area 412 and the desired page outside the page flipping interface 41. In the embodiment, if users continuously slide the sliding bar, the information on the preview area 412 is continuously updated. Users can search their desired pages by dragging the sliding bar and reading the content on the page flipping interface 41. If a desired page is found and the users stops dragging the sliding bar for a first preset time period T1, the detect module 31 does not detect any sliding signal in the first preset time period T1, the detect module 31 signals the display control module 34 to display the desired page outside the page flipping interface 41

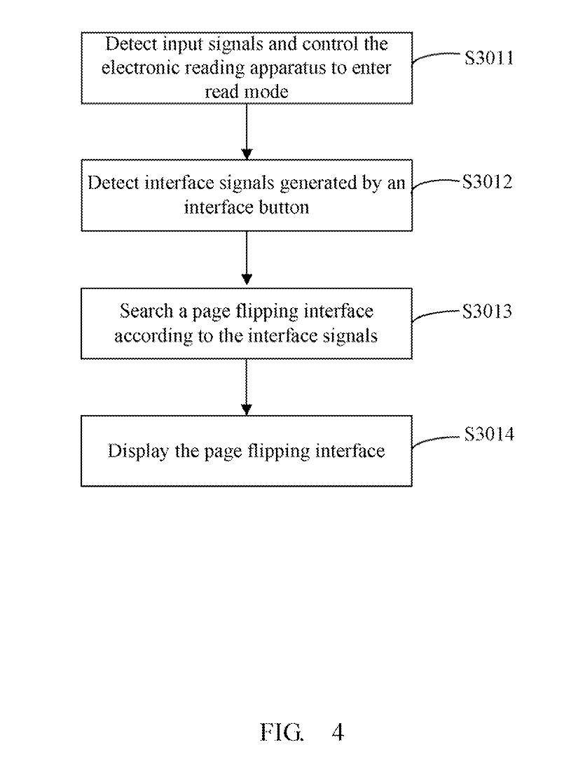

Referring to the FIG. 4, in the embodiment, the step S301 includes steps S3011˜S3014: in the step S3011, the detect module 31 detects input signals generated by a read mode button 21, and controls the electronic reading apparatus 100 to enter a read mode.

In the step S3012, the detect module 31 further detects interface signals generated by an interface button 22.

In the step S3013, the searching module 33 searches the page flipping interface 41 according to the interface signals.

In the step S3014, the display control module 34 displays the page flipping interface 41 on the display unit 10.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic reading apparatus, comprising:
an input unit to generate a read mode signal, an interface display signal and a sliding signal in response to user inputs.
a display unit to display visual information to users; and
a processing unit to:
control the electronic reading apparatus to enter a read mode according to the read mode signal and display a page of a reading file on the display unit;
display a page flipping interface on the display unit according to the interface display signal, the page flipping interface containing a preview area and an input area;
determine a sliding direction and a sliding distance of a sliding operation on the input area according to the sliding signal and determine a flipping direction and a number of pages needed to be flipped corresponding to the sliding direction and the sliding distance; and
display information of the page after flipping pages corresponding to the sliding direction and the sliding distance in the preview area and display the page outside the page flipping interface.

2. The electronic reading apparatus as claimed in claim 1, wherein the information of the page after flipping pages comprises the content and the page number of the page.

3. The electronic reading apparatus as described in claim 1, wherein the processing unit determines the number of pages needed to be flipped according a table, the table is stored in a storage unit and records a relationship between the sliding distance and the number of pages to be flipped over.

4. The electronic reading apparatus as described in claim 1, wherein the page flipping interface comprises a menu area, the menu area displays a cover button, a catalog button and a backward button, when the cover button is clicked, a number of icons of covers of the reading files are displayed on the preview area; when the catalog button is clicked, the catalog of a desired reading file on the preview area; when the backward button is clicked, the electronic reading apparatus return to a previously displayed page.

5. The electronic reading apparatus as described in claim 4, wherein the page flipping interface further comprises an input area, a touch panel overlays the menu area and the input area, a sliding bar is displayed in the input area and configured to be dragged by a user to operate the electronic reading apparatus.

6. The electronic reading apparatus as described in claim 1, wherein the input unit further comprises a read mode button and interface buttons, the read mode button generating the read mode signal to case the electronic reading apparatus to enter a read model; the interface buttons comprises a left interface button and a right interface button, when one of the interface buttons is operated by the user, the page flipping interface is displayed on a corresponding side of the display unit.

7. The electronic apparatus as described in claim 6, wherein the page flipping interface shields a portion of the current page on the electronic reading apparatus.

8. The electronic reading apparatus as described in claim 5, wherein when users continuously slide the sliding bar, content on the preview area is continuously updated.

9. The electronic reading apparatus as described in claim 1, wherein the processing unit further comprises a analyzing module and a searching module; the analyzing module determines whether the endure time of a sliding operation according to a sliding signal exceeds a preset time, and transmits the sliding signal to the searching module if the endure time exceeds the preset time, the searching module determines a sliding direction and a sliding distance of the sliding operation according to the sliding signal to determine the flipping direction and the number of pages to be flipped over, the flipping direction corresponds to the sliding direction and the number of pages to be flipped over corresponds to the sliding distance of the sliding operation.

10. The electronic reading apparatus as described in claim 1, wherein the processing unit comprises a detect module, if the detect module does not detect a sliding signal in a first preset time period T1, the processing unit displays the page whose information is shown in the preview area outside the page flipping interface.

11. The electronic reading apparatus as described in claim 10, wherein if the detect module does not detect the sliding signals in a second preset time period T2, the detect module signals the processing unit to stop displaying the page flipping interface.

12. A page flipping method applied in an electronic reading apparatus, comprising:
controlling the electronic reading apparatus to enter a read mode, and display a page of a reading file under the read mode;
displaying a page flipping interface according to an interface display signal, the page flipping interface containing a preview area and an input area;
determining a sliding direction and a sliding distance of a sliding operation on the input area;
determining a flipping direction and a number of pages needed to be flipped over according to the sliding direction and the sliding distance;
flipping over the number of pages to a desired page according to the flipping direction and showing information on the desired page in the preview area; and
displaying the desired page outside the page flipping interface.

13. The method as described in claim 12, wherein a content in the preview area comprises the content and the page number of the desired page, and the chapter containing the desired page.

14. The method as described in claim 12, the step of displaying a page flipping interface according to an interface display signal, further comprising:
detecting interface signals generated by a interface button of the electronic reading apparatus;
searching the page flipping interface according to the interface signals;
displaying the page flipping interface on a display unit of the electronic reading apparatus.
